(19) United States
(12) Patent Application Publication
(10) Pub. No.: US 2006/0026129 A1
(43) Pub. Date: Feb. 2, 2006

(54) Selective manufacturing resource planning methods and systems

(75) Inventors: Robert J. Zeman, Williamson, NY (US); John J. Wickett, Ontario, NY (US); Terrence J. Dutton, Webster, NY (US); John F. Wallenhorst, Greece, NY (US)

Correspondence Address: Kermit Lopez/Luis Ortiz;ORTIZ & LOPEZ, PLLC, P.O. Box 4484, Albuquerque, NM, 87196-4484, US

(73) Assignee: Xerox Corporation

(21) Appl. No.: 10/890,044

(22) Filed: Jul. 13, 2004

(51) Int. Cl. G06F 17/30

(52) U.S. Cl. 707/3

(57) ABSTRACT

Methods and systems for generating an updated manufacturing resource plan from data selectively retrieved from a manufacturing resource plan (MRP) data base are disclosed. A portion of a manufacturing resource planning database associated with a manufacturing resource plain can be accessed, in response to a user input by a user of a plurality of selective criteria. A set of particular data can then be retrieved from the portion of said manufacturing resource database in response to said input by said user of said plurality of selective criteria. Thereafter, an updated manufacturing resource plan (MRP) can be automatically generated based on the set of particular data retrieved from the accessed portion of said manufacturing resource planning database.

### TECHNICAL FIELD

Embodiments are generally related to manufacturing resource planning (MRP) methods and systems. Embodiments also relate to data-processing methods and systems. Embodiments are additionally related to data-processing networks.

### BACKGROUND OF THE INVENTION

The process of manufacturing a product presents many challenges to bring the product to market for the least cost and within schedule, while also maintaining product quality. To this end, a manufacturing resource plan (MRP) can be implemented to streamline the manufacturing, production and distribution processes. Manufacturing the product for the least possible cost is important in all industries. Inventory, for example, is one of the primary costs associated with manufacturing a product. Transactions between a buyer and a supplier in the manufacturing industries are also factors important in MRP operations.

For example, in conventional MRP systems, a buyer can create a request for quotation (RFQ), which is a request to a supplier to provide a quote for a needed item. The RFQ can include a description of the item, the quantity needed, a price, and a desired delivery date. One RFQ is created for each supplier from whom the buyer wishes a quote. Once the RFQ's have been received by the suppliers, the buyer waits for the quotes. When a supplier receives an RFQ, the information on the RFQ may be entered into a database, if the supplier has such a database. The supplier then performs the necessary inquiries within his or her company in order to provide a quote in response to the RFQ. The supplier creates the quote, and submits it to the buyer.

In such MRP systems, when the buyer receives the quotes from the suppliers, the buyer must then perform a thorough analysis to determine which supplier from which to order each item. Comparisons of the quote terms are conducted. The buyer may negotiate with each supplier before all of the terms are agreed upon. Once the terms have been agreed upon, the buyer creates a purchase order (PO) for each supplier, setting forth all of the terms, and submitting it to the suppliers. The POs function as binding contracts between the buyer and the suppliers.

The buyer then manages the POs to ensure their proper execution, and to troubleshoot any problems which may arise. Each supplier also manages the proper execution of the PO at his or her company and communicates with the buyer on a regular basis to supply the current status. Occasionally, the supplier requests changes to the PO, in which case the buyer and supplier renegotiate the terms and executes a new PO.

In the production of some of these manufacturing resource documents, i.e., the RFQ and the PO, one onerous task facing the buyer is managing information concerning various parts and connecting them with the suppliers who may supply these parts. One approach involves manually entering each part and connecting it with the supplier(s). Such an approach can extremely time consuming.

Another approach is to supply the data as a catalog. The catalog may be one of three types: a text file, an Extensible Markup Language (XML) file, or a process file. The text file contains the parts data configured with the connected suppliers but with no formatting. The XML file contains the parts data configured with the connected suppliers with some formatting. The process file contains the parts data configured according to a predetermined process. With the catalog approach, however, when an item in the catalog or a connection to a supplier is changed, or when the process is changed, the entire catalog must be changed. This approach is inflexible.

MRP methodologies attempt to alleviate such drawbacks. One type of MRP system or methodology in use is the MRP II (or ERP) system, which can perform its planning functions by starting with the schedule of finished goods, working with the quantities needed and the dates required, followed by back-calculating when the various manufacturing operations need to be performed, and determining when and where and in what quantities raw materials are required to produce all needed goods on schedule and in the quantities required. In executing the required algorithms (e.g., running an MRP gen), the MRP software or module considers a wide variety of factors including production equipment availability, capacity, throughput, yield changeover, purchasing time lead, and the like. Users must be excluded from using the system during the “gens” so that the data does not change while the algorithms execute. These so-called “gens” can take hours to run and process.

Accordingly, there exists a need for an improved method and system for manufacturing resource planning. The present invention addresses such a need.

### BRIEF SUMMARY

It is, therefore, a feature of the present invention to provide for an improved data-processing system.

It is another feature of the present invention to provide for improved methods and systems for generating and updating manufacturing resource plans.

It is a further feature of the present invention to provide for methods and systems for decreasing the time involved in updating and regenerating manufacturing resource plans.

Aspects of the present invention relate to methods and systems for generating an updated manufacturing resource plan from data selectively retrieved from a manufacturing resource plan (MRP) data base. A portion of a manufacturing resource planning database associated with a manufacturing resource plan can be accessed, in response to a user input by a user of a plurality of selective criteria. A set of particular data can then be retrieved from the portion of said manufacturing resource database in response to said input by said user of said plurality of selective criteria. Thereafter, an updated manufacturing resource plan (MRP) can be automatically generated based on the set of particular data retrieved from the accessed portion of said manufacturing resource planning database.

The user can be initially prompted to input said plurality of selective criteria for accessing said manufacturing resource planning database. As a result, the user can modify the updated manufacturing resource plan while said updated manufacturing resource plan is automatically generated based on said set of particular data retrieved from said portion of said manufacturing resource planning database. In general, the updated manufacturing resource plan can include MRP data, such as, but not limited to material requirements planning data, capacity requirements planning data and/or inventory criteria. The plurality of selective criteria can include, but is not limited to, for example, purchase order criteria, and work order criteria.

### BRIEF DESCRIPTION OF THE DRAWINGS

The accompanying figures, in which like reference numerals refer to identical or functionally-similar elements throughout the separate views and which are incorporated in and form part of the specification further illustrate embodiments of the present invention.

FIG. 1 illustrates a pictorial representation of a computer system in which an embodiment of the present invention can be implemented;

FIG. 2 illustrates a block diagram of a representative hardware environment of the processing unit of the computer system depicted in FIG. 1;

FIG. 3 illustrates a block diagram of a network in which a preferred embodiment can be implemented;

FIG. 4 illustrates a high-level flow chart of operations depicting logical operational steps that can be implemented in accordance with a preferred embodiment of the present invention; and

FIG. 5 illustrates a block diagram depicting a system that can be implemented in accordance with a preferred embodiment of the present invention.

### DETAILED DESCRIPTION OF THE INVENTION

The particular values and configurations discussed in these non-limiting examples can be varied and are cited merely to illustrate embodiments of the present invention and are not intended to limit the scope of the invention.

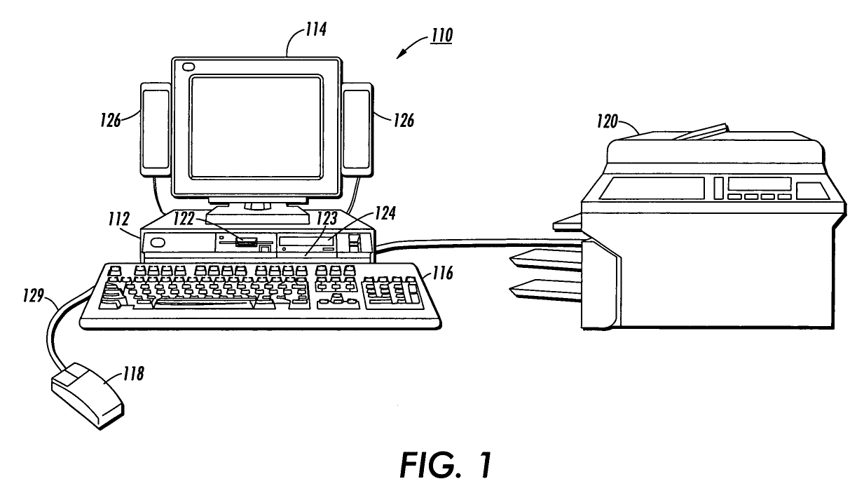

With reference now to the figures and in particular with reference to FIG. 1-3, there is depicted an example computer or data-processing system in which the preferred embodiment can be implemented. As depicted in FIG. 1, data-processing system 110 includes processing unit 112, display device 114, keyboard 116, pointing device 118, rendering device 120, and speakers 126. Rendering device 120 can be implemented as a device such as a printer and/or scanner. Processing unit 112 receives input data from input devices such as keyboard 116, pointing device 118, and local area network interfaces (not illustrated) and presents output data to a user via display device 114, printer 120, and speakers 126. Because processing unit 112 can be networked into a computer network, devices such as rendering device 120 can function as a network device such as a network scanner or multifunction device. Data-processing system 110 thus can function not only as a stand-alone desktop personal computer, but can also function as a networked data-processing system with multifunction capabilities such as printing, scanning, copying and so forth.

Keyboard 116 is that part of data-processing system 110 that resembles a typewriter keyboard and that enables a user to control particular aspects of the computer. Because information flows in one direction, from keyboard 114 to processing unit 112, keyboard 116 functions as an input-only device. Functionally, keyboard 116 represents half of a complete input/output device, the output half being video display terminal 114. Keyboard 116 includes a standard set of printable characters presented in a “QWERTY” pattern typical of most typewriters. In addition, keyboard 116 includes a calculator-like numeric keypad at one side. Some of these keys, such as the “control,” “alt,” and “shift” keys can be utilized to change the meaning of another key. Other special keys and combinations of keys can be utilized to control program operations or to move either text or cursor on the display screen of video-display terminal 114.

Video-display terminal 114 is the visual output of data-processing system 110. As indicated herein, video-display terminal 114 can be a cathode-ray tube (CRT) based video display well-known in the art of computer hardware. But, with a portable or notebook-based computer, video-display terminal 114 can be replaced with a liquid crystal display (LCD) based or gas, plasma-based, flat-panel display.

Pointing device 118 is preferably utilized in conjunction with a graphical user-interface (GUI) in which hardware components and software objects are controlled through the selection and the manipulation of associated, graphical objects displayed within display device 114. Although data-processing system 110 is illustrated with a mouse for pointing device 118, other graphical-pointing devices such as a graphic tablet, joystick, track ball, touch pad, or track pad could also be utilized. Pointing device 118 features a casing with a flat bottom that can be gripped by a human hand. Pointing device 118 can include buttons on the top, a multidirectional-detection device such as a ball on the bottom, and cable 129 that connects pointing device 118 to processing unit 112.

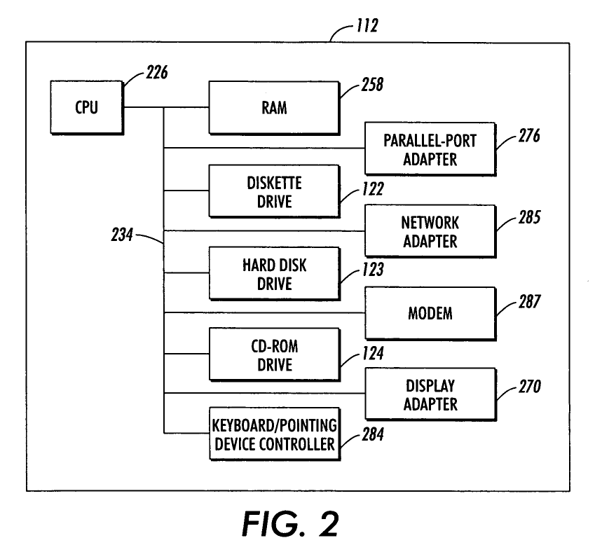

To support storage and retrieval of data, processing unit 112 further includes diskette drive 122, hard-disk drive 123, and CD-ROM drive 124, which are interconnected with other components of processing unit 112, and which are further described below under the description for FIG. 2. Data-processing system 110 can be implemented utilizing any suitable computer. But, a preferred embodiment of the present invention can apply to any hardware configuration that allows the display of windows, regardless of whether the computer system is a complicated, multi-user computing apparatus, a single-user workstation, or a network appliance that does not have non-volatile storage of its own.

Referring to FIG. 2, there is depicted a block diagram of the principal components of processing unit 112. CPU 226 is connected via system bus 234 to RAM (Random Access Memory) 258, diskette drive 122, hard-disk drive 123, CD-ROM drive 124, keyboard/pointing-device controller 284, parallel-port adapter 276, network adapter 285, display adapter 270, and modem 287. Although the various components of FIG. 2 are drawn as single entities, each may consist of a plurality of entities and may exist at multiple levels.

Processing unit 112 includes central processing unit (CPU) 226, which executes instructions. CPU 226 includes the portion of data-processing system 110 that controls the operation of the entire computer system, including executing the arithmetical and logical functions contained in a particular computer program. Although not depicted in FIG. 2, CPU 226 typically includes a control unit that organizes data and program storage in a computer memory and transfers the data and other information between the various parts of the computer system. CPU 226 generally includes an arithmetic unit that executes the arithmetical and logical operations, such as addition, comparison, and multiplication. CPU 226 accesses data and instructions from and stores data to volatile RAM 258.

CPU 226 can be implemented, for example, as any one of a number of processor chips, or any other type of processor, which are available from a variety of vendors. Although data-processing system 110 is shown to contain only a single CPU and a single system bus, the present invention applies equally to computer systems that have multiple CPUs and to computer systems that have multiple buses that each performs different functions in different ways.

RAM 258 comprises a number of individual, volatile-memory modules that store segments of operating system and application software while power is supplied to data-processing system 110. The software segments are partitioned into one or more virtual-memory pages that each contains a uniform number of virtual-memory addresses. When the execution of software requires more pages of virtual memory than can be stored within RAM 258, pages that are not currently needed are swapped with the required pages, which are stored within non-volatile storage devices 122 or 123. RAM 258 is a type of memory designed such that the location of data stored in it is independent of the content. Also, any location in RAM 258 can be accessed directly without needing to start from the beginning.

Hard-disk drive 123 and diskette drive 122 are electromechanical devices that read from and write to disks. The main components of a disk drive are a spindle on which the disk is mounted, a drive motor that spins the disk when the drive is in operation, one or more read/write heads that perform the actual reading and writing, a second motor that positions the read/write heads over the disk, and controller circuitry that synchronizes read/write activities and transfers information to and from data-processing system 110.

A disk itself is typically a round, flat piece of flexible plastic (e.g., floppy disk) or inflexible metal (e.g. hard disk) coated with a magnetic material that can be electrically influenced to hold information recorded in digital form. A disk is, in most computers, the primary method for storing data on a permanent or semi permanent basis. Because the magnetic coating of the disk must be protected from damage and contamination, a floppy disk (e.g., 5.25 inch) or micro-floppy disk (e.g., 3.5 inch) is encased in a protective plastic jacket. But, any size of disk could be used. A hard disk, which is very finely machined, is typically enclosed in a rigid case and can be exposed only in a dust free environment. Keyboard/pointing-device controller 284 interfaces processing unit 112 with keyboard 116 and graphical-pointing device 118. In an alternative embodiment, keyboard 116 and graphical-pointing device 118 have separate controllers. Display adapter 270 can translates graphics data from CPU 226 into video signals utilized to drive display device 114.

Finally, processing unit 112 includes network adapter 285, modem 287, and parallel-port adapter 276, which facilitate communication between data-processing system 110 and peripheral devices or other computer systems. Parallel-port adapter 276 transmits printer-control signals to printer 120 through a parallel port. Network adapter 285 connects data-processing system 110 to an un-illustrated local area network (LAN). A LAN provides a user of data-processing system 110 with a means of electronically communicating information, including software, with a remote computer or a network logical-storage device. In addition, a LAN supports distributed processing, which enables data-processing system 110 to share a task with other computer systems linked to the LAN., which can also be implemented in the context of a wireless local area network (WLAN).

Modem 287 supports communication between data-processing system 110 and another computer system over a standard telephone line. Furthermore, through modem 287, data-processing system 110 can access other sources such as a server, an electronic bulletin board, and the Internet or the well-known World Wide Web.

The configuration depicted in FIG. 1 is but one possible implementation of the components depicted in FIG. 2. Portable computers, laptop computers, and network computers or Internet appliances are other possible configurations. The hardware depicted in FIG. 2 may vary for specific applications. For example, other peripheral devices such as optical-disk media, audio adapters, or chip-programming devices, such as PAL or EPROM programming devices well-known in the art of computer hardware, may be utilized in addition to or in place of the hardware already depicted.

As will be described in detail below, aspects of the preferred embodiment pertain to specific method steps implementable on computer systems. In an alternative embodiment, the invention may be implemented as a computer program-product for use with a computer system, which can be implemented as devices such as networked computer workstations, computer desktop and peripheral devices, servers and the like. The programs defining the functions of the preferred embodiment can be delivered to a computer via a variety of signal-bearing media, which include, but are not limited to, (a) information permanently stored on non-writable storage media (e.g., read-only memory devices within a computer such as CD-ROM disks readable by CD-ROM drive 124); (b) alterable information stored on writable storage media (e.g., floppy disks within diskette drive 122 or hard-disk drive 123); or (c) information conveyed to a computer by a communications media, such as through a computer or telephone network, including wireless communications. Such signal-bearing media, when carrying computer-readable instructions that direct the functions of on or more embodiments present invention, and/or represent alternative embodiments of the present invention.

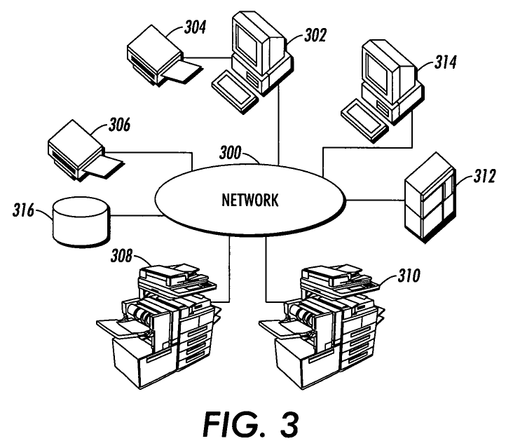

FIG. 3 illustrates a block diagram of a network 300 in which an embodiment can be implemented. Network 300 can be implemented as a computer network through which a variety of data-processing system devices can communicate. An example of network 300 is a LAN. For example, network 300 can communicate with a server 312. Additionally a computer 302 can be linked to a multi-function rendering device 304 or another multi-function rendering device 306 can be linked directly through network 300. Additionally, a computer workstation 314 can be linked to network 300 along with one or more digital copiers 308 and 310. Note that digital copiers 308 can and 310 have the capability to scan documents. Thus, documents scanned via copiers 308 and 310 can be saved as computer files (e.g., JPEG, PDF, TIFF, etc) and transmitted to computer 302 for storage within a memory location thereof.

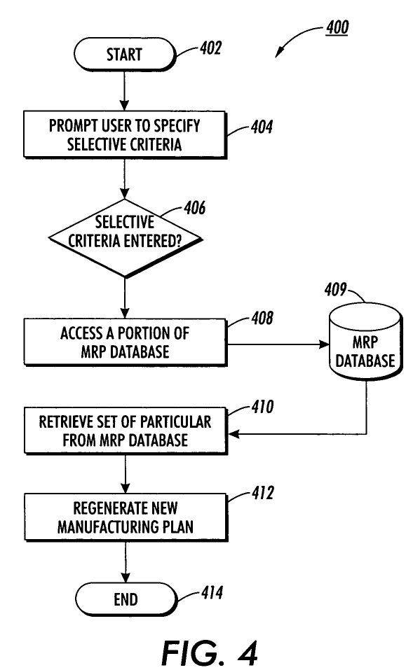

The documents stored within a memory location of computer 302 can then be retrieved via computer 302 and rendered via, for example, rendering devices 304 and/or 306, or copiers 308 and/or 310. Note that documents and data can also be stored within a database 316, which can be implemented as a manufacturing resource planning (MRP) database. An example of an MRP database is disclosed in further detail herein with respect to FIG. 4 (i.e., see MRP database 409). Computer 302 is generally analogous to data-processing system 110 of FIG. 1, and thus, the documents scanned via copiers 508 can be stored within a memory location of data-processing system 110 and process via a processor such as CPU 226 and/or a CPU associated within any of the other rendering devices, such rendering devices 304, 306 and/or copiers 308, 310.

Note that a variety of different types of rendering devices can be adapted for utilization with preferred or alternative embodiments. For example, different types of copiers can be utilized to implement copiers 308 and 310. An example of such a copier is disclosed in U.S. Pat. No. 6,636,899, “Architecture for Software for Remote Maintenance of a Machine Such as a Copier,” which is assigned to the Xerox Corporation and issued to Rabb, et al on Oct. 21, 2003. Another example of a copier, which can be utilized in accordance with an embodiment, is disclosed in U.S. Pat. No. 6,587,227, “Copier Having Contoured Track Guides,” which is also assigned to the Xerox Corporation and issued to Jack K. Fullerton on Jul. 1, 2003.

A further example of a copier, which can be utilized in accordance with an embodiment, is disclosed in U.S. Pat. No. 6,175,714, “Document Control System and Method for Digital Copiers,” which is assigned to the Xerox Corporation and issued to Peter A. Crean on Jan. 16, 2001. Another example of a copier, which can be utilized in accordance with an embodiment, is disclosed in U.S. Pat. No. 6,057,930, “Architecture for a Digital Copier and Printer for Handling Print Jobs Associated with a Network,” which is assigned to the Xerox Corporation and issued to Blossey et al on May 2, 2000. U.S. Pat. Nos. 6,636,899, 6,587,227, 6,175,714 and 6,057,930 are incorporated herein by reference.

FIG. 4 illustrates a high-level flow chart 400 of operations depicting logical operational steps that can be implemented in accordance with a preferred embodiment of the present invention. The process can be initiated, as indicated at block 402. Thereafter, as depicted at block 404, an operation can be performed in which a user is initially prompted to input a plurality of selective criteria for accessing a manufacturing resource planning (MRP) database 409. MRP database 409 is associated with a complete manufacturing resource plan (MRP). Note that as utilized herein the acronym “MRP” can be utilized to refer both to the terms “manufacturing resource plan” and “manufacturing resource planning”. As depicted at block 406, a test can be performed to determine if the user had entered the selective criteria. If not, then the process terminates, as indicated at block 414.

If, however, it is determined that the user has provided the selective criteria, then as indicated at block 408, an operation can be performed in which a portion of the MRP database 409 can be accessed. Note that MRP database 409 of FIG. 4 is analogous to MRP database 316 of FIG. 3. Next, as depicted at block 410, a set of particular data can be retrieved from said portion of said MRP database 409 in response to said input by said user of the selective criteria. Thereafter, as indicated at block 412, an updated MRP can be automatically generated based on the set of particular data retrieved from a portion of the MRP database. Based on flow chart 400, it can be appreciated that the user can modify the updated MRP while the updated MRP is automatically generated.

The updated MRP can include a variety of data, such as, for example, material requirements planning data and/or capacity requirements planning data. Additionally, the selective criteria can include criteria such as inventory criteria, purchase order criteria, and/or work order criteria. The process flow operations of flow chart 400 provides a selective MRP methodology that allows users to specify certain criteria (e.g., plurality of selective criteria) to access a subset or a portion or MRP database 409 in order to regenerate a new MRP (e.g., material and capacity).

The methodology of flow chart 400 takes into consideration all elements associated with the part or component being re-planned (e.g., inventory, purchase order, work order, etc.). Because the selective MRP of flow chart 400 only results in accessing a portion of the whole MRP database 409, the resulting MRP generation can be completed in a matter of minutes as compared to a full generation, which may take hours. Systems users are thus still able to inquire and update while the generation is taking place.

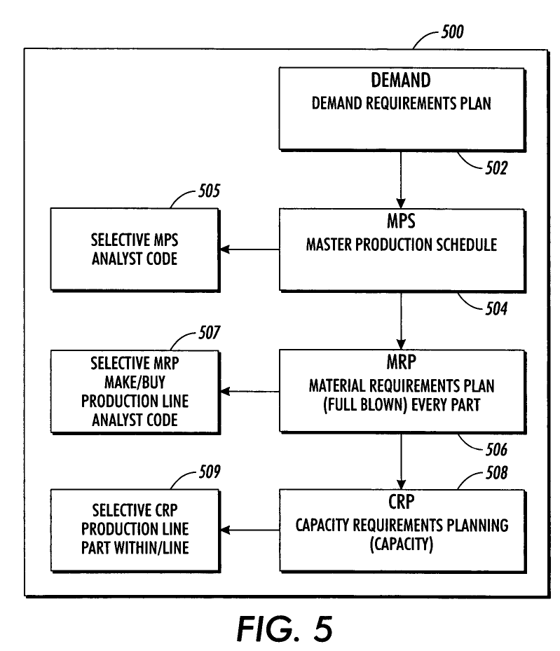

The logical operations depicted FIGS. 4-5 can be implemented in the context of a “module” or a group of such modules. In the computer programming arts, a module can be typically implemented as a collection of routines and data structures that performs particular tasks or implements a particular abstract data type. Modules are generally composed of two parts. First, a software module may list the constants, data types, variable, routines and the like that that can be accessed by other modules or routines. Second, a software module can be configured as an implementation, which can be private (i.e., accessible perhaps only to the module), and that contains the source code that actually implements the routines or subroutines upon which the module is based. Such modules can also be referred to as “instruction media”. Such instruction media can reside in, for example, a memory of a data-processing system and then retrieved and processed via a processor, such as, for example, a central processing unit and/or microprocessor or plurality of microprocessors.

Thus, for example, the term module, as utilized herein generally refers to software modules or implementations thereof. Such modules can be utilized separately or together to form a program product that can be implemented through instruction media in the form of signal-bearing media, including transmission media and recordable media. Flow chart 400 of FIG. 4, for example, can therefore be implemented as a module or group of such modules, which are stored within a memory location of data-processing system, such as, for example, data-processing system 112 of FIGS. 1-2.

FIG. 5 illustrates a block diagram depicting a system 500 that can be implemented in accordance with a preferred embodiment of the present invention. System 500 can be implemented as a plurality of modules, including a demand requirements plan module 502, which provides demand data to a master production schedule (MPS) module 504. MPS module 504 can provide data to an MRP module 506, which can be implemented as a manufacturing resource plan (MRP), including a materials requirement plan (i.e., full blown) associated with every part, component or element of the overall plan. MRP module 506 can in turn provide data to a capacity requirements planning (CRP) module. A selective MPS analyst code module 505 can retrieve data from MPS module 504. Similarly, a selective MRP module 507 can process operations involving make and/or buy decisions, production line decisions, and/or analyst code decisions. A selective CRP module 509 can also process selective production line capacity data, and/or date related to specifics parts or components within the production line itself.

The embodiments disclosed in FIGS. 4-5 thus disclose what can be described as “selective MRP” that allows a user to select a sub-set of the finished good parts, using one of several alternative selection criteria, and thereafter executing the “gen” for only those parts. A number of benefits thus can result, including faster execution times, improved user access, iterative planning processes, and interactive planning processes. Because of the smaller number of finished good parts driving the calculations, such calculations can be accomplished in minutes instead of hours, thereby resulting in faster execution times. Additionally, users are excluded from only those finished good parts being re-planned while the algorithms execute, allowing full functionality and access to all other parts in the system while the “gens” are running, thereby resulting in improved user access.

The fast execution times allow planner users to work iteratively, changing parameters which affect the planning process, re-running the “gen”, and analyzing the results until the users are satisfied with the production and purchasing plans generated by the system. The faster execution times also allow planner users to respond to changes in finished goods requirements by immediately and interactively re-working production and purchasing plans to meet new and changing requirements. Such a functionality permits businesses to deliver a higher and more responsive level of customer service, while simultaneously keep manufacturing plants running efficiently.

It can be appreciated that various other alternatives, modifications, variations, improvements, equivalents, or substantial equivalents of the teachings herein that, for example, are or may be presently unforeseen, unappreciated, or subsequently arrived at by applicants or others are also intended to be encompassed by the claims and amendments thereto.

1. A method, comprising:
accessing a portion of a manufacturing resource planning database associated with a manufacturing resource plan in response to a user input by a user of a plurality of selective criteria;
retrieving a set of particular data from said portion of said manufacturing resource database in response to said input by said user of said plurality of selective criteria; and
thereafter automatically generating an updated manufacturing resource plan based on said set of particular data retrieved from said portion of said manufacturing resource planning database.

2. The method of claim 1 further comprising initially prompting said user to input said plurality of selective criteria for accessing said manufacturing resource planning database.

3. The method of claim 1 further comprising permitting said user to modify said updated manufacturing resource plan while said updated manufacturing resource plan is automatically generated based on said set of particular data retrieved from said portion of said manufacturing resource planning database.

4. The method of claim 1 wherein said updated manufacturing resource plan comprises material requirements planning data.

5. The method of claim 1 wherein said updated manufacturing resource plan comprises capacity requirements planning data.

6. The method of claim 1 wherein said plurality of selective criteria comprises inventory criteria.

7. The method of claim 1 wherein said plurality of selective criteria comprises purchase order criteria.

8. The method of claim 1 wherein said plurality of selective criteria comprises work order criteria.

9. A system, comprising:
a manufacturing resource planning database, wherein a portion of said manufacturing resource database is accessible by a user in response a user input by said user of a plurality of selective criteria;
a set of particular data retrievable from said portion of said manufacturing resource database in response to said input by said user of said plurality of selective criteria; and
an updated manufacturing resource plan, which is automatically generated based on said set of particular data retrieved from said portion of said manufacturing resource planning database.

10. The system of claim 9 further comprising wherein said user is initially prompted to input said plurality of selective criteria for accessing said manufacturing resource planning database.

11. The system of claim 9 wherein user is permitted to modify said updated manufacturing resource plan while said updated manufacturing resource plan is automatically generated based on said set of particular data retrieved from said portion of said manufacturing resource planning database.

12. The system of claim 9 wherein said updated manufacturing resource plan comprises material requirements planning data.

13. The system of claim 9 wherein said updated manufacturing resource plan comprises capacity requirements planning data.

14. A program product residing in a data-processing system, comprising:
instruction media residing in a data-processing system for accessing a portion of a manufacturing resource planning database associated with a manufacturing resource plan in response to a user input by a user of a plurality of selective criteria;
instruction media residing in a data-processing system for retrieving a set of particular data from said portion of said manufacturing resource database in response to said input by said user of said plurality of selective criteria; and
instruction media residing in a data-processing system for thereafter automatically generating an updated manufacturing resource plan based on said set of particular data retrieved from said portion of said manufacturing resource planning database.

15. The program product of claim 14 further comprising instruction media residing in a data-processing system for initially prompting said user to input said plurality of selective criteria for accessing said manufacturing resource planning database.

16. The program product of claim 14 further comprising instruction media residing in a data-processing system for permitting said user to modify said updated manufacturing resource plan while said updated manufacturing resource plan is automatically generated based on said set of particular data retrieved from said portion of said manufacturing resource planning database.

17. The program product of claim 14 wherein said plurality of selective criteria comprises at least one of the following types of criteria: inventory criteria, purchase order criteria, and work order criteria.

18. The program product of claim 14 wherein said instruction media further comprises signal bearing media.

19. The program product of claim 18 wherein said instruction media comprises recordable media.

20. The program product of claim 18 wherein said instruction media comprises transmission media.
